(19) United States
(12) Patent Application Publication
(10) Pub. No.: US 2024/0399356 A1
(43) Pub. Date: Dec. 5, 2024

(54) Synthetic Method of Ultrafine Catalyst Powder

(71) Applicant: Wuxi Dongheng New Energy Technology Co., Ltd., Wuxi (CN)

(72) Inventors: Yudong SHEN, Wuxi (CN); Rentao WAN, Wuxi (CN)

(21) Appl. No.: 18/802,119

(22) Filed: Aug. 13, 2024

Related U.S. Application Data
(63) Continuation of application No. PCT/CN2022/081374, filed on Mar. 17, 2022.

(30) Foreign Application Priority Data
Feb. 23, 2022 (CN) 2022102065804

(51) Int. Cl. B01J 37/08; B01J 35/40; B82Y 40/00; C01B 32/162

(52) U.S. Cl. CPC B01J 37/088; B01J 35/40; B82Y 40/00; C01B 32/162; C01P 2004/13

(57) ABSTRACT

Disclosed is a synthetic method of ultrafine catalyst powder. The synthetic method of ultrafine catalyst powder includes the following steps: (1) uniformly mixing iron nitrate nonahydrate, cobalt nitrate hexahydrate, magnesium nitrate hexahydrate, aluminum nitrate nonahydrate, ammonium heptamolybdate, citric acid and water, and then heating and concentrating to obtain concentrated liquor; (2) uniformly mixing EDTA, an aqueous ammonia solution and urea to obtain an EDTA solution; then, uniformly mixing the concentrated liquor with the EDTA solution to obtain mixed liquor; and (3) carrying out spray pyrolysis on the mixed liquor at 450-500° C. for 5-10 min to obtain the ultrafine catalyst powder. According to the present disclosure, the organic salt solution can be rapidly evaporated and decomposed, and thus the ultrafine catalyst powder with uniformly distributed components is synthesized; and the particle size of the prepared ultrafine catalyst powder is controlled within a range of less than 5 μm.

### TECHNICAL FIELD

The present disclosure relates to a synthetic method of ultrafine catalyst powder, belonging to the technical field of catalysts.

### BACKGROUND

Carbon nanotubes, as a popular material, are used in various fields such as touch screen materials, hydrogen storage materials, and composite materials, and have been widely applied to the new energy lithium battery industry. Research has shown that the addition of carbon nanotubes significantly improves the capacity, service life, and safety of lithium batteries, which is attributed to their excellent conductivity and better mechanical properties.

The structure and morphology of carbon nanotubes have a great influence on their physical properties, such as tube diameters, tube lengths, degrees of graphitization, and other key parameters. By adjusting and controlling the synthesis conditions of a catalyst and the factors such as particle size, a carbon nanotube can be synthesized with the tube diameter being within a controllable range (0.3-200 nm).

### SUMMARY

### Technical Problem

At present, production methods for preparing carbon nanotube catalysts mainly include a precipitation method, an impregnation method, a sol-gel method, and the like. However, carbon nanotubes prepared by these methods have the problem of a smaller specific surface areas which is one of the key parameters of the carbon nanotube.

### Technical Solutions

In order to solve the above problems, the present disclosure employs a two-step complexation method to prepare a solution, and the solution is subjected to spray pyrolysis to form ultrafine catalyst powder; the particle size of the prepared ultrafine catalyst powder is controlled within a range of less than 5 μm by adjusting the influence factors such as the amount of urea added, and the pyrolysis temperature; and the specific surface area of a carbon nanotube prepared by using the ultrafine catalyst through a chemical vapor deposition method reaches 600-1000 m²/g.

The first object of the present disclosure is to provide a synthetic method of ultrafine catalyst powder, including the following steps:
(1) uniformly mixing iron nitrate nonahydrate, cobalt nitrate hexahydrate, magnesium nitrate hexahydrate, aluminum nitrate nonahydrate, ammonium heptamolybdate, citric acid and water, and then heating and concentrating to obtain concentrated liquor;
(2) uniformly mixing EDTA, an aqueous ammonia solution and urea to obtain an EDTA solution; then, uniformly mixing the concentrated liquor in step (1) with the EDTA solution to obtain mixed liquor; and
(3) carrying out spray pyrolysis on the mixed liquor in step (2) at 450-500° C. for 5-10 min to obtain the ultrafine catalyst powder.

In one embodiment of the present disclosure, the mass ratio of the iron nitrate nonahydrate, the cobalt nitrate hexahydrate, the magnesium nitrate hexahydrate, the aluminum nitrate nonahydrate, the ammonium heptamolybdate, the citric acid and the EDTA is 8.1:(5.5-6):102.6:30:(0.7-0.75):(99-100):(83-84).

In one embodiment of the present disclosure, the mass ratio of the water in step (1) to all the other raw materials in step (1) is (2.3-3):1.

In one embodiment of the present disclosure, in step (2), the mass ratio of the aqueous ammonia solution to the EDTA is (5.8-7):1.

In one embodiment of the present disclosure, the uniformly mixing in step (1) is stirring for dissolving.

In one embodiment of the present disclosure, the heating and concentrating in step (1) is heating with a water bath at 90-95° C. in a water bath kettle, stirring at 300-500 rpm, and concentrating for 2-4 h in an open way.

In one embodiment of the present disclosure, the concentration of the aqueous ammonia solution in step (2) is 25 wt %.

In one embodiment of the present disclosure, in step (2), the mass ratio of the urea to the EDTA is (0.05-0.3):1.

In one embodiment of the present disclosure, the spray pyrolysis in step (3) is injecting the mixed liquor in step (2) into an atomizer of a spray tower through a peristaltic pump at a flow rate of 100 ml/min, and performing the spray pyrolysis by using 300 L/min compressed air as a carrier gas.

The second object of the present disclosure is to provide ultrafine catalyst powder prepared by the method according to the present disclosure.

The third object of the present disclosure is to provide application of the ultrafine catalyst powder in preparation of carbon nanotubes.

In one embodiment of the present disclosure, a method for preparing carbon nanotubes includes the following steps:
(1) weighing 0.3 g of the ultrafine catalyst powder and placing same in the middle of a Φ80 mm quartz tube furnace; allowing the tube furnace to heat up to 450° C. at a heating rate of 10° C./min in an air atmosphere, and keeping the tube furnace at 450° C. for 240 min;
(2) changing the atmosphere into nitrogen to replace the air in the furnace for 30 min at a nitrogen flow rate of 1000 sccm; then, introducing hydrogen for reducing the catalyst for 30 min at a hydrogen flow rate of 1000 sccm;
(3) heating up to 700° C., stopping the introduction of hydrogen, adjusting the nitrogen flow rate to 300 sccm and introducing ethylene at an ethylene flow rate of 300 sccm for carrying out a constant temperature reaction for 60 min; and after that, stopping the introduction of ethylene, cooling down naturally, and taking out a product.

### The Beneficial Effects of the Present Disclosure

(1) The present disclosure defines the mass ratio of magnesium salt to aluminum salt as 3.42:1 (with a stoichiometric ratio of 10:2), so that the magnesium salt and the aluminum salt are complexed with the citric acid and the EDTA solution to form an unstable highly-active organometallic complex, and the complex is decomposed at high temperature to obtain the ultrafine catalyst powder.
(2) According to the present disclosure, with the combination of the spray pyrolysis method, the organic salt solution can be rapidly evaporated and decomposed, and thus the ultrafine catalyst powder with uniformly distributed components is synthesized; and the particle size of the prepared ultrafine catalyst powder is controlled within a range of less than 5 μm by adjusting the influence factors such as the amount of urea added, and the pyrolysis temperature.
(3) The ultrafine catalyst powder provided by the present disclosure can be used for catalytic cracking of carbon sources in a fixed bed or a moving bed, and the synthesis of carbon nanotubes with specific surface areas of 600-1000 m²/g can be realized by using the ultrafine catalyst powder. The performance of the carbon nanotubes is significantly improved, for example, the carbon nanotubes are smaller in tube diameters, longer in lengths, and higher in liquid absorption, with the lengths being controlled within a range of 30-120 μm, and the tube diameters being controlled within a range of 3-7 nm, which is attributed to the characteristics of the ultrafine catalyst powder, such as small particle size, high activity, and stable structure.

### BRIEF DESCRIPTION OF FIGURES

FIG. 1 is a scanning electron microscope spectrum (1 μm) of an ultrafine catalyst from Example 3.

FIG. 2 is a scanning electron microscope spectrum (5 μm) of an ultrafine catalyst from Example 3.

FIG. 3 is a scanning electron microscope spectrum (2 μm) of a carbon nanotube in Example 4 prepared by using the ultrafine catalyst from Example 3.

FIG. 4 is a scanning electron microscope spectrum (0.2 μm) of a carbon nanotube in Example 4 prepared by using the ultrafine catalyst from Example 3.

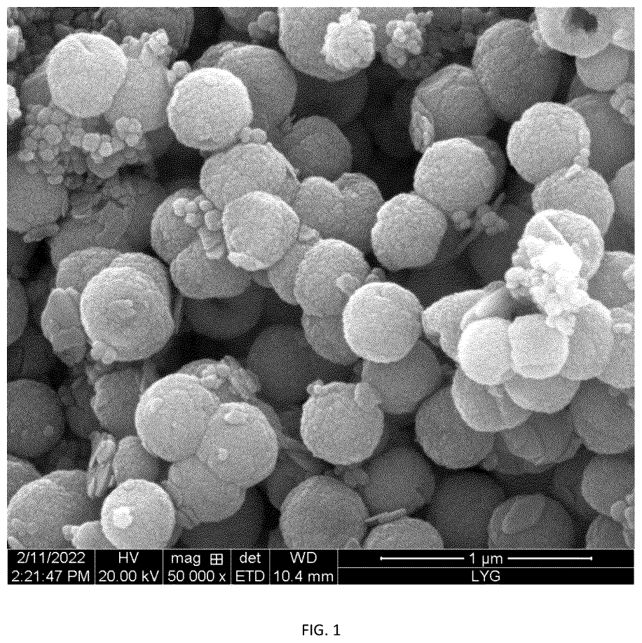

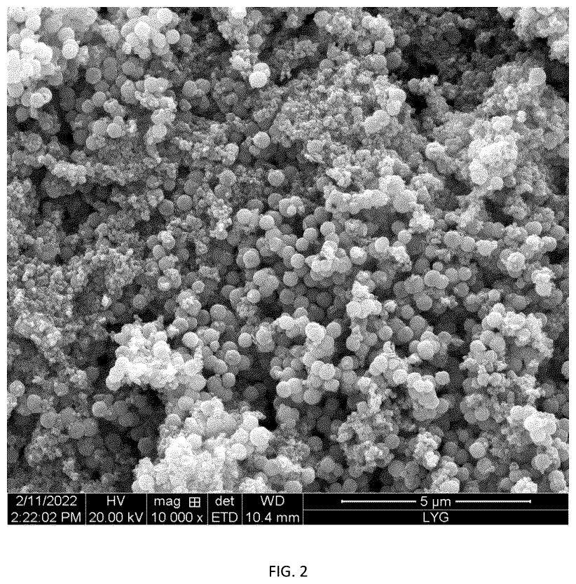

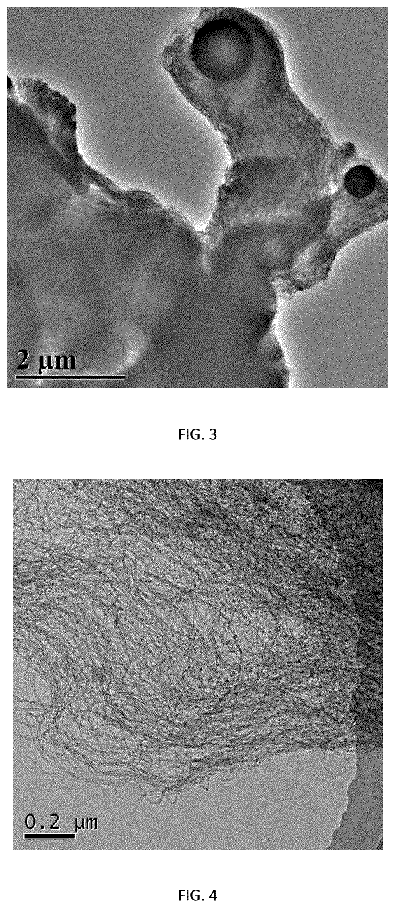

### DETAILED DESCRIPTION

Exemplary examples of the present disclosure will be described below, and it should be understood that the examples are for the purpose of better illustrating the present disclosure and are not intended to limit the present disclosure.

### Test Methods:

Test for particle size of catalyst: Malvern MS2000 laser particle size analyzer was used for testing.

Test for specific surface areas of carbon nanotubes: Specific surface area analyzer JW-BK122W was used for testing.

### Example 1

A synthetic method of ultrafine catalyst powder includes the following steps:
(1) 8.1 g of iron nitrate nonahydrate, 5.8 g of cobalt nitrate hexahydrate, 102.6 g of magnesium nitrate hexahydrate, 30 g of aluminum nitrate nonahydrate, 585 g of pure water, 0.71 g of ammonium heptamolybdate tetrahydrate, and 99.9 g of anhydrous citric acid were weighed by using a 1000 ml beaker in turn, and the mixture was stirred to be dissolved; then, the obtained mixture was heated with a water bath at 92° C. in a water bath kettle, stirring blades were installed for stirring at a rotating speed of 400 rpm, and the solution was concentrated for 2 h in an open way to obtain concentrated liquor;
(2) 83.6 g of EDTA, 493 g of aqueous ammonia (25 wt. %) and 4.2 g of urea were weighed by using a 2000 ml beaker in turn, and the mixture was stirred to be dissolved at room temperature in a sealing way, so that an EDTA solution was formed; the concentrated liquor in step (1) was mixed with the EDTA solution, stirring blades were installed for stirring at a rotating speed of 400 rpm, and the mixture was stirred in a sealing way for 30 min at room temperature for mixing well, so that mixed liquor was obtained; and
(3) the mixed liquor in step (2) was injected into an atomizer of a spray tower through a peristaltic pump at a flow rate of 100 mL/min, 300 L/min compressed air was used as a carrier gas, the pyrolysis temperature of a heating furnace was set to 450° C., and spray pyrolysis was performed for 8 min, so that the ultrafine catalyst powder was obtained.

### Example 2

A synthetic method of ultrafine catalyst powder includes the following steps:
(1) 8.1 g of iron nitrate nonahydrate, 5.8 g of cobalt nitrate hexahydrate, 102.6 g of magnesium nitrate hexahydrate, 30 g of aluminum nitrate nonahydrate, 585 g of pure water, 0.71 g of ammonium heptamolybdate tetrahydrate, and 99.9 g of anhydrous citric acid were weighed by using a 1000 ml beaker in turn, and the mixture was stirred to be dissolved; then, the obtained mixture was heated with a water bath at 92° C. in a water bath kettle, stirring blades were installed for stirring at a rotating speed of 400 rpm, and the solution was concentrated for 2 h in an open way to obtain concentrated liquor;
(2) 83.6 g of EDTA, 493 g of aqueous ammonia (25 wt. %) and 4.2 g of urea were weighed by using a 2000 ml beaker in turn, and the mixture was stirred to be dissolved at room temperature in a sealing way, so that an EDTA solution was formed; the concentrated liquor in step (1) was mixed with the EDTA solution, stirring blades were installed for stirring at a rotating speed of 400 rpm, and the mixture was stirred in a sealing way for 30 min at room temperature for mixing well, so that mixed liquor was obtained; and
(3) the mixed liquor in step (2) was injected into an atomizer of a spray tower through a peristaltic pump at a flow rate of 100 ml/min, 300 L/min compressed air was used as a carrier gas, the pyrolysis temperature of a heating furnace was set to 500° C., and spray pyrolysis was performed for 8 min, so that the ultrafine catalyst powder was obtained.

### Example 3

A synthetic method of ultrafine catalyst powder includes the following steps:
(1) 8.1 g of iron nitrate nonahydrate, 5.8 g of cobalt nitrate hexahydrate, 102.6 g of magnesium nitrate hexahydrate, 30 g of aluminum nitrate nonahydrate, 585 g of pure water, 0.71 g of ammonium heptamolybdate tetrahydrate, and 99.9 g of anhydrous citric acid were weighed by using a 1000 ml beaker in turn, and the mixture was stirred to be dissolved; then, the obtained mixture was heated with a water bath at 92° C. in a water bath kettle, stirring blades were installed for stirring at a rotating speed of 400 rpm, and the solution was concentrated for 2 h in an open way to obtain concentrated liquor;
(2) 83.6 g of EDTA, 493 g of aqueous ammonia (25 wt. %) and 16.7 g of urea were weighed by using a 2000 ml beaker in turn, and the mixture was stirred to be dissolved at room temperature in a sealing way, so that an EDTA solution was formed; the concentrated liquor in step (1) was mixed with the EDTA solution, stirring blades were installed for stirring at a rotating speed of 400 rpm, and the mixture was stirred in a sealing way for 30 min at room temperature for mixing well, so that mixed liquor was obtained; and
(3) the mixed liquor in step (2) was injected into an atomizer of a spray tower through a peristaltic pump at a flow rate of 100 mL/min, 300 L/min compressed air was used as a carrier gas, the pyrolysis temperature of a heating furnace was set to 450° C., and spray pyrolysis was performed for 8 min, so that the ultrafine catalyst powder was obtained.

### Comparative Example 1

A synthetic method of catalyst powder includes the following steps:
(1) 8.1 g of iron nitrate nonahydrate, 5.8 g of cobalt nitrate hexahydrate, 102.6 g of magnesium nitrate hexahydrate, 15 g of aluminum nitrate nonahydrate, 559.2 g of pure water, 0.71 g of ammonium heptamolybdate tetrahydrate, and 92.2 g of anhydrous citric acid were weighed by using a 1000 ml beaker in turn, and the mixture was stirred to be dissolved; then, the obtained mixture was heated with a water bath at 92° C. in a water bath kettle, stirring blades were installed for stirring at a rotating speed of 400 rpm, and the solution was concentrated for 2 h in an open way to obtain concentrated liquor;
(2) 77.2 g of EDTA, 455.2 g of aqueous ammonia (25 wt. %) and 4.2 g of urea were weighed by using a 2000 ml beaker in turn, and the mixture was stirred to be dissolved at room temperature in a sealing way, so that an EDTA solution was formed; the concentrated liquor in step (1) was mixed with the EDTA solution, stirring blades were installed for stirring at a rotating speed of 400 rpm, and the mixture was stirred in a sealing way for 30 min at room temperature for mixing well, so that mixed liquor was obtained; and
(3) the mixed liquor in step (2) was injected into an atomizer of a spray tower through a peristaltic pump at a flow rate of 100 mL/min, 300 L/min compressed air was used as a carrier gas, the pyrolysis temperature of a heating furnace was set to 450° C., and spray pyrolysis was performed for 8 min, so that the catalyst powder was obtained.

### Comparative Example 2

A synthetic method of catalyst powder includes the following steps:
(1) 8.1 g of iron nitrate nonahydrate, 5.8 g of cobalt nitrate hexahydrate, 102.6 g of magnesium nitrate hexahydrate, 60 g of aluminum nitrate nonahydrate, 671.1 g of pure water, 0.71 g of ammonium heptamolybdate tetrahydrate, and 115.3 g of anhydrous citric acid were weighed by using a 1000 ml beaker in turn, and the mixture was stirred to be dissolved; then, the obtained mixture was heated with a water bath at 92° C. in a water bath kettle, stirring blades were installed for stirring at a rotating speed of 400 rpm, and the solution was concentrated for 2 h in an open way to obtain concentrated liquor;
(2) 96.4 g of EDTA, 569 g of aqueous ammonia (25 wt. %) and 4.2 g of urea were weighed by using a 2000 ml beaker in turn, and the mixture was stirred to be dissolved at room temperature in a sealing way, so that an EDTA solution was formed; the concentrated liquor in step (1) was mixed with the EDTA solution, stirring blades were installed for stirring at a rotating speed of 400 rpm, and the mixture was stirred in a sealing way for 30 min at room temperature for mixing well, so that mixed liquor was obtained; and
(3) the mixed liquor in step (2) was injected into an atomizer of a spray tower through a peristaltic pump at a flow rate of 100 mL/min, 300 L/min compressed air was used as a carrier gas, the pyrolysis temperature of a heating furnace was set to 450° C., and spray pyrolysis was performed for 8 min, so that the catalyst powder was obtained.

### Comparative Example 3

The citric acid in step (1) of Example 1 was omitted, the content of EDTA was adjusted to be 235.6 g, the mass of aqueous ammonia was 1389.8 g, and the others were consistent with those in Example 1, so as to obtain a catalyst.

### Comparative Example 4

The EDTA in step (2) of Example 1 was omitted, the content of citric acid was adjusted to be 154.9 g, and the others were consistent with those in Example 1, so as to obtain a catalyst.

### Comparative Example 5

The pyrolysis temperature of the heating furnace in Example 1 was adjusted to be 300° C., and the others were consistent with those in Example 1, so as to obtain a catalyst.

### Comparative Example 6

The pyrolysis temperature of the heating furnace in Example 1 was adjusted to be 600° C., and the others were consistent with those in Example 1, so as to obtain a catalyst.

The catalyst powder obtained from the Examples and the Comparative examples were tested. The test results are as follows:

TABLE 1
Particle size test results

| Example | Particle size D50 (μm) |
|---|---|
| Example 1 | 0.6 |
| Example 2 | 1.1 |
| Example 3 | 0.4 |
| Comparative Example 1 | 6.9 |
| Comparative Example 2 | 8.3 |
| Comparative Example 3 | 21.2 |
| Comparative Example 4 | 52.2 |
| Comparative Example 5 | 156.1 |
| Comparative Example 6 | 26.2 |

It can be seen from Table 1 that when the pyrolysis temperature of the heating furnace is higher, the obtained ultrafine nano-powder has a larger particle size, which may be due to the fact that the high temperature may cause the crystal nucleus of the nano-powder to agglomerate, thereby resulting in an increase in the particle size thereof; and ultrafine catalyst powder with a smaller particle size can be obtained by adding urea, because the combustion assisted by oxidation of ethanol makes the atomized droplets of the powder disperse into smaller particles, resulting in smaller catalyst powder.

### Example 4

A method for preparing carbon nanotubes includes the following steps:
0.3 g of each of the catalysts from the Examples and the Comparative examples was weighed and placed in the middle of a @80 mm quartz tube furnace; the tube furnace was enabled to heat up to 450° C. at a heating rate of 10° C./min in an air atmosphere, and kept at 450° C. for 240 min to improve the thermal stability of the catalysts;
the atmosphere was changed into nitrogen to replace the air in the furnace for 30 min at a nitrogen flow rate of 1000 sccm, so that the oxygen content in the furnace was enabled to be as low as possible; then, hydrogen was introduced for reducing the catalyst for 30 min at a hydrogen flow rate of 1000 sccm; and
the furnace was enabled to heat up to 700° C., the introduction of hydrogen was stopped, the nitrogen flow rate was adjusted to 300 sccm, an ethylene flow rate was adjusted to 300 sccm, a constant temperature reaction was carried out for 60 min, then the introduction of ethylene was stopped, and a product was cooled down naturally and taken out.

The obtained product carbon nanotubes were tested. The test results are as follows:

TABLE 2
Test results of carbon nanotubes

| | Specific surface area | |
|---|---|---|
| Catalyst | (m²/g) | Yield (CNT.g/Cat.g) |
| Example 1 | 784 | 30.4 |
| Example 2 | 620 | 35.0 |
| Example 3 | 965 | 26.2 |
| Comparative Example 1 | 375 | 28.1 |
| Comparative Example 2 | 490 | 16.2 |
| Comparative Example 3 | 368 | 7.2 |
| Comparative Example 4 | 226 | 5.6 |
| Comparative Example 5 | 252 | 11.2 |
| Comparative Example 6 | 496 | 21.0 |

Although the present disclosure has been disclosed as above in exemplary examples, it is not intended to limit the present disclosure. Anyone familiar with this technology can make various changes and modifications without departing from the spirit and scope of the present disclosure. Therefore, the protection scope of the present disclosure shall be as defined in the Claims.

What is claimed is:

1. A synthetic method of ultrafine catalyst powder, comprising the following steps:
(1) uniformly mixing iron nitrate nonahydrate, cobalt nitrate hexahydrate, magnesium nitrate hexahydrate, aluminum nitrate nonahydrate, ammonium heptamolybdate, citric acid and water, and then heating and concentrating to obtain a concentrated liquor;
(2) uniformly mixing EDTA, an aqueous ammonia solution and urea to obtain an EDTA solution; then, uniformly mixing the concentrated liquor in step (1) with the EDTA solution to obtain a mixed liquor; and
(3) carrying out spray pyrolysis on the mixed liquor obtained in step (2) at 450-500° C. for 5-10 minutes to obtain the ultrafine catalyst powder.

2. The method according to claim 1, wherein the mass ratio of the iron nitrate nonahydrate, the cobalt nitrate hexahydrate, the magnesium nitrate hexahydrate, the aluminum nitrate nonahydrate, the ammonium heptamolybdate, the citric acid and the EDTA is 8.1:(5.5-6):102.6:30:(0.7-0.75):(99-100):(83-84).

3. The method according to claim 1, wherein the mass ratio of the water in step (1) to all the other raw materials in step (1) is (2.3-3):1.

4. The method according to claim 1, wherein in step (2), the mass ratio of the aqueous ammonia solution to the EDTA is (5.8-7):1.

5. The method according to claim 1, wherein in step (2), the mass ratio of the urea to the EDTA is (0.05-0.3):1.

6. The method according to claim 1, wherein the heating and concentrating in step (1) is heating with a water bath at 90-95° C. in a water bath kettle, stirring at 300-500 rpm, and concentrating for 2-4 hours in an open way.

7. The method according to claim 1, wherein the concentration of the aqueous ammonia solution in step (2) is 25 wt %.

8. The method according to claim 1, wherein the spray pyrolysis in step (3) is injecting the mixed liquor in step (2) into an atomizer of a spray tower through a peristaltic pump at a flow rate of 100 mL/min, and performing the spray pyrolysis by using 300 L/min compressed air as a carrier gas.

9. Ultrafine catalyst powder prepared by the method according to claim 1.

10. A method for preparing carbon nanotubes using the ultrafine catalyst powder according to claim 9, comprising the following steps:
(1) weighing 0.3 g of the ultrafine catalyst powder and placing same in the middle of a @80 mm quartz tube furnace; allowing the tube furnace to heat up to 450° C. at a heating rate of 10° C./min in an air atmosphere, and keeping the tube furnace at 450° C. for 240 minutes;
(2) changing the atmosphere into nitrogen to replace the air in the furnace for 30 minutes at a nitrogen flow rate of 1000 sccm; then, introducing hydrogen for reducing the catalyst for 30 minutes at a hydrogen flow rate of 1000 sccm;
(3) heating up to 700° C., stopping the introduction of hydrogen, adjusting the nitrogen flow rate to 300 sccm and introducing ethylene at an ethylene flow rate of 300 sccm for carrying out a constant temperature reaction for 60 minutes; and after that, stopping the introduction of ethylene, cooling down naturally, and taking out a product.
